(19) United States
(12) Patent Application Publication
(10) Pub. No.: US 2021/0209678 A1
(43) Pub. Date: Jul. 8, 2021

(54) SYSTEM AND METHOD FOR FINANCIAL TRANSACTIONS BETWEEN CREDITORS AND DEBTORS

(71) Applicants: Valerii Borovyk, Chernigiv (UA); Evgeniy Borovyk, Chernigiv (UA); Tamara Borovyk, Chernigiv (UA)

(72) Inventors: Valerii Borovyk, Chernigiv (UA); Evgeniy Borovyk, Chernigiv (UA); Tamara Borovyk, Chernigiv (UA)

(21) Appl. No.: 16/733,165

(22) Filed: Jan. 2, 2020

(51) Int. Cl. G06Q 40/02; G06Q 20/10; G06Q 20/42; G06Q 20/24

(52) U.S. Cl. CPC G06Q 40/025; G06Q 20/24; G06Q 20/42; G06Q 20/108

(57) ABSTRACT

A financial system, method, and computer readable medium facilitate financial operations between creditors and borrowers. The financial system configured to allow a borrower to pay a significantly lower percentage for using a loan than on a traditional platform. The borrower provides a loan to another borrower in the same amount and for the same period. Due to the steady increase in the share of loans according to the inventive algorithm and architecture of the present system, platform, and computer readable medium, the total cost of loans will decrease by reduction its value if the borrower becomes an investor for the next willing to take out a loan. The advantage of the financial system, method, and computer readable medium is attraction of more customers to use the system and reduction of total cost of the loans.

### FIELD OF THE INVENTION

The invention relates to methods and systems supporting online consumer interactions by a user in a networked system, and more particularly to lending system and method to facilitate financial operations between creditors and borrowers.

### BRIEF DESCRIPTION OF THE INVENTION

The art is replete with various methods and systems supporting online consumer interactions by a user in a networked system to facilitate financial operations between creditors and borrowers. Currently, the most common and widely used method is known as P2P which stands for peer-to-peer or person-to-person. The method of utilizing the P2P system is pretty simple. In particular, all lenders and borrowers register on the P2P platforms based on Internet resources or programs that are installed on smartphones and thereafter enter into loan agreements therein. Both borrowers and lenders agree on the amount of debt, interest and maturity. The P2P platform charges a commission for its services, such as percentage of the loan amount. There can be more than one lender and more than one borrower per a particular loan. The P2P platform does not assume credit risks—all loans are issued at the expense of creditors.

The service provided by the P2P platform makes scoring of borrowers, provides services for collection of overdue debts and support of the movement of money. Interest rates are set by creditors (lenders) that compete for the lowest bid in a reverse auction, or determined by the intermediary as a result of the analysis of the borrower's loan. As a result of the automation of many services, the overhead costs of intermediary companies are reduced, and their service is cheaper than providing services by conventional financial institutions. Consequently, borrowers can receive money at a lower percentage, and lenders receive higher incomes. Equal lending does not fit into any of the three categories of traditional financial institutions such as depositaries, investors, and insurers as an alternative financial service.

The key features of equal lending include the following: loans are provided on commercial terms; the possibility of lack of communication or any previous relationship between creditors and borrowers; mediation of a specialized credit institution; economic operations are carried out on-line. In addition, the lenders can choose which loans they want to fund, and loans are not secured and not protected by the conditions of state insurance.

Consequently, when P2P-lending in credit relations enter into equal terms and enter into an agreement with each other on the loan value through an intermediary—a microfinance organization or a bank. These prior art P2P systems provide numerous advantages. For example, the advantages are the high percentage of approvals, favorable rates, the minimum set of documents and the high speed of acceptance. The prior art P2P system also provide advantages for the investor, such as the benefits are low risk, favorable rates and low operating costs.

The borrowers have numerous advantages as well. In particular, the borrowers, who do not have enough money, or entrepreneurs who need funding—all of them are having difficulty in obtaining loans from banks. For various reasons—or they do not meet the high standards of the bank to the borrower and receive a refusal, or the amount of credit does not meet their needs. And when banks, private investors, venture funds cannot help a business or a private individual with financing, they are assisted by numerous P2P lending platforms. The main feature of P2P lending is that it occurs without a traditional intermediary in the form of a bank and, as a rule, in online mode. Borrowers are looking for funds on lending platform sites, where they receive credit funds on more favorable terms than in traditional financial institutions. Investors are also coming to the same platforms in search of earnings on the invested money.

Some of the prior art systems and methods are disclosed in U.S. Pat. No. 7,877,353 B2 to Ahmed et al. and U.S. Pat. No. 7,958,019 B2 to Ahmad et al. Alluding to the above, U.S. Pat. No. 7,877,353 B2 to Ahmed et al., for example, teaches a computer-implemented method and system in which a network-based interaction environment includes a plurality of peer-to-peer nodes being able to communicate directly with each other using a peer-to-peer protocol and a peer-to-peer client application, the plurality of peer-to-peer nodes including a first peer-to-peer client and a second peer-to-peer client.

A first peer-to-peer client application running on the first peer-to-peer client maintains persistent buddy information on the first peer-to-peer client, the persistent buddy information including a buddy list identifying trusted peer-to-peer nodes of the plurality of peer-to-peer nodes. A second peer-to-peer client application runs on the second peer-to-peer client to maintain persistent reputation information on the second peer-to-peer client, the persistent reputation information including information related to the reputation of the first peer-to-peer client in the network-based interaction environment.

U.S. Pat. No. 7,958,019 B2 to Ahmed et al, also teaches a computer-implemented method and system in which a network-based interaction environment includes a plurality of peer-to-peer nodes being able to communicate directly with each other using a peer-to-peer protocol and a peer-to-peer client application, and a first peer-to-peer client application running on a first peer-to-peer client of the plurality of peer-to-peer nodes. The first peer-to-peer client application maintains persistent user account information on the first peer-to-peer client, the persistent information being related to a plurality of user accounts for conducting e-commerce interactions on the network-based interaction environment, the plurality of user accounts including at least one user account based on a plurality of roles of a corresponding user.

However, prior art systems and methods have several negatives or drawbacks. These prior art systems do not provide the opportunity to raise funds wherein at the same time allowing reduction of its value whereby the borrower becomes an investor (lender) himself for the next borrower willing to take out a loan thereby decreasing the total cost of the loans.

One of such drawbacks is failure to offer the debtor the opportunity to pay the debt forward by providing it to a third party, instead of returning to the original creditor. This contract may include provisions that the debtor may repay the debt in kind by offering the same amount as a bad partner after they receive funds and under the same conditions.

To the extent as being effective, there is always a need for new and improved systems and methods to facilitate financial operations between creditors and borrowers. The present invention aims to solve this problem by simple and convenient means.

### SUMMARY OF THE INVENTION

Present invention relates a financial system, method, and computer readable medium facilitate financial operations between creditors and borrowers. A typical lending platform is serving lenders and borrowers by keeping records of data objects needed for loan operations such as contracts, loan accounts, investment account. The following process events related to loan process such as installment transfers, repayments, delinquent events, and default events. Lending processes from business side have constraints between lender and borrower, that are also mirrored in information systems such as trust to borrower from lender side. Lender's goal is to receive high interest rate wherein borrower goal to pay low interest rate.

To reduce constraints limitations presented by the aforementioned typical lending platform, an inventive new component for processing “repay and invest” was introduced. The financial system of the present invention is configured to allow a borrower to pay a significantly lower percentage for using a loan than on a traditional platform. The borrower provides a loan to another borrower in the same amount and for the same period. Due to the steady increase in the share of loans according to the inventive algorithm and architecture of the present system, method, and computer readable medium, the total cost of loans will decrease by reduction its value if the borrower becomes an investor for the next willing to take out a loan.

The inventive system, method, and computer readable medium provides a module for receiving business “repay and invest” event, such as a PFP2P module. The PFP2P module is operably communicated with a scoring module. The general inventive functionality of the present invention is as follows. When the borrower received money from the lender, the borrower not only repays full amount from the loan with interest, but also additional amount for forward investment. The signal from the scoring module will provide information to the borrower requesting the response if the borrower is ready to pay the money owed plus interest as agreed with the lender. If the borrower selects to pay the amount owed plus originally agreed interest then the amount owed plus the interest as agreed will be paid back to the lender. Alternatively, the borrower may select to proceed with savings option wherein signal will be forwarded from the inventive PFP2P module to the scoring module operably communicated with the lender. The module will provide the borrower with options to lend additional funds in return to payment of lower interest. The module will provide the borrower with selection of options.

The functional application of the PFP2P module is as follows. When PFP2P request is initiated, the request is send to a validation module for validating the PFP2P event against repayment option conditions. If for any reasons, the request is not validated then the process continues to standard repayment process through a module. If, however, the request is validated, then the request is forwarded to a request credit score module to be forwarded to the scoring module for scoring process at a scoring process module for calculation of new loan rate.

The scoring module returns newly calculated rate back to the PFP2P module and more particularly to a recalculation module for recalculation of a new interest rate recalculates and to be apply new interest rate to a loan account. A repayment event module performs repayment with recalculated credit rate. The information is then forwarded to a module which creates instance of investment account for former borrower, which now becomes lender.

Difference between PFP2P paid amount and repayment amount is booked by a booking module as initial investment amount. The information is then forwarded from the booking module to an initiation module which initiates standard P2P lending process with the lender (former borrower) as investor and some other party.

An advantage of the present invention is to provide an improved financial system, method, and computer readable medium which attracts more customers to use the system and reduces total cost of the loans.

An advantage of the present invention is to provide the improved financial system, method, and computer readable medium which helps to radically raise the trust level for parties, thereby accepting much lower interest rate by lenders.

Another advantage of the present invention is to provide the improved financial system, method, and computer readable medium which removes any prior art constraints present in typical P2P lending.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic block diagram of the present inventive financial system; and

FIG. 2 is a schematic view of the inventive module of the system shown in FIG. 1.

### DETAILED DESCRIPTION OF THE INVENTION

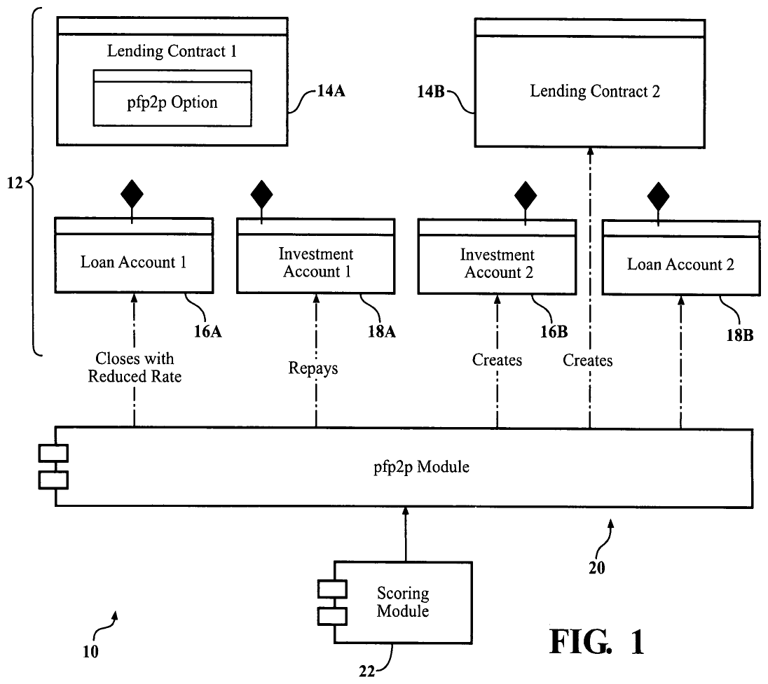

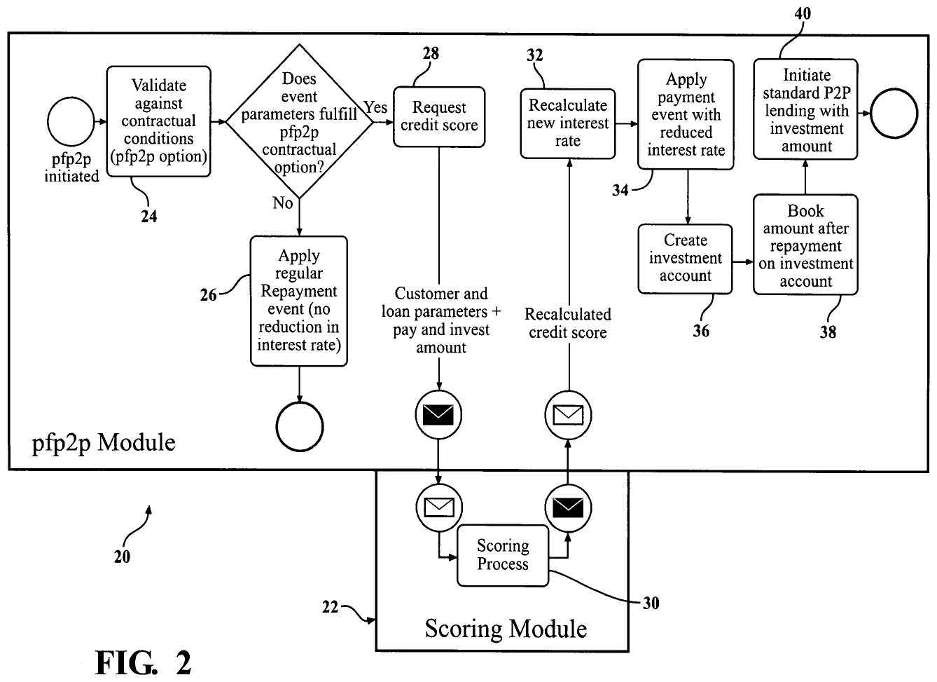

Referring to the FIGS. 1 and 2 of the present invention, a system, a method, and a non-transitory processor-readable medium, i.e. a computer readable medium, for facilitating financial operations between borrowers and lenders are described herewith. Because explicit identification of object-oriented constructs expressed through the syntax of high-level object-oriented programming languages is lost during compilation to binary code (e.g., translation of a source code definition or representation of an application to a binary code definition or representation of the application such as a machine code or byte-code definition), potential security vulnerabilities can be obscured during static analysis of the resulting binary code. For example, because information about an object (e.g., the class on which the object is based, the size of the object, the number and types or sizes of properties of the object, and the number of functionalities accessible to the object via a dispatch table) is typically not expressed in binary code, determining whether indirect operations relative to the object expose security vulnerabilities can be difficult without the source code from which the binary code was generated.

As a specific example, an indirect operation can result in arbitrary code execution security vulnerabilities if the binary code does not include run-time validation to ensure that the indirect operation does not operate outside or beyond the object (i.e., at memory addresses not allocated to or shared by the object). Some binary code representations of applications, however, do include information about objects. Such information can be included in binary code as run-time type information (RTTI) or debugging information that is compiled into the binary code. Nevertheless, because the binary code representations of many applications do not include such information (e.g., to discourage reverse engineering of these applications), robust methodologies and systems for analyzing binary code based on (or derived from) source code using object-oriented techniques should not assume availability of such information.

Implementations discussed herein analyze operations described in binary code to identify objects based on those operations. Said differently, implementations discussed herein reconstruct, at least partially, objects (or representations of objects) by inferring the structure of such objects based on operations described in binary code. Thus, implementations discussed herein can identify objects and attributes such as a size thereof without referring to (or independent of) source code or explicit information about such objects which may or may not be included in the binary code. Furthermore, implementations discussed herein perform security vulnerability analyses of binary code representations of applications using such objects. For example, implementations discussed herein can identify security vulnerabilities such as type confusion vulnerabilities that can result in arbitrary code execution, code injection, application failure, or other undesirable or unintended behavior of an application using information about objects identified by analysis of operations described in binary code.

As used herein, the term “software module” refers to a group of code representing instructions that can be executed at a computing system or processor to perform some functionality. Applications, software libraries (e.g., statically-linked libraries or dynamically-linked libraries), and application frameworks are examples of software modules. Additionally, as used herein, the terms “operations described in binary code” and “operations defined in binary code” and similar terms or phrases refer to operations described by code representing instructions that exist in a binary code representation (or binary representation) of a software module. In some implementations discussed herein, operations described in binary code are analyzed (e.g., parsed and interpreted) in a representation other than a binary code representation of a software module. For example, an object analysis system can analyze operations described in binary code using an intermediate representation of a software module derived from a binary code representation of that software module.

Accordingly, implementations discussed herein with reference to analysis of operations described in binary code should be understood to refer to analysis of those operations using a binary code representation of a software module or a representation of the software module derived from the binary code representation.

A variable within a memory is a memory location at which one or more values can be stored. Such a memory location can be at a processor memory (e.g., a register or cache), at a system memory (e.g., a Random Access Memory (RAM) of a computing system), or at some other memory. Operations within binary code that operate on such variables can refer to a memory address (either absolute or relative to another memory address such as an offset from a stack pointer) of that memory location. Thus, the identifier (e.g., memory address) of an object can be stored as a value at a memory location with a memory address that is used by operations within the binary code.

Accordingly, as used herein, terms such as “identifier of an object” and “memory address of an object” should be understood to refer to the identifier (e.g., memory address) itself or to a variable at which a value representing the identifier is stored. As used herein, the term “module” refers to a combination of hardware (e.g., a processor such as an integrated circuit or other circuitry) and software (e.g., machine- or processor-executable instructions, commands, or code such as firmware, programming, or object code).

FIG. 1 is a schematic block diagram of the financial system or platform, generally shown at 10. In a typical peer to peer (P2P) platform financial, generally shown at 12, a person such as a lender borrowers funds from another person such as a borrower by signing contract. For execution of the described process it is required to have contract condition (option) as shown at 14A and 14B. As part of the contract execution, a typical lending system creates loan account 16A and 16B and an investment account records 18A and 18B. During standard P2P contract live cycle there is no change in standard execution.

The inventive system, method, and computer readable medium provides a module for receiving business “repay and invest” event, such as a PFP2P module, generally indicated at 20. The PFP2P module 20 is operably communicated with a scoring module 22. FIG. 2 shows a detailed schematic view of the inventive PFP2P module 20 operably communicated with the scoring module 22. The general inventive functionality of the present invention is as follows. When the borrower received money from the lender, the borrower not only repays full amount from the loan with interest, but also additional amount for forward investment. The signal from the scoring module 22 will provide information to the borrower requesting the response if the borrower is ready to pay the money owed plus interest as agreed with the lender. If the borrower selects to pay the amount owed plus originally agreed interest then the amount owed plus the interest as agreed will be paid back to the lender. Alternatively, the borrower may select to proceed with savings option wherein signal will be forwarded from the inventive PFP2P module 20 to the scoring module 22 operably communicated with the lender. The module will provide the borrower with options to lend additional funds in return to payment of lower interest. The module will provide the borrower with selection of options.

The inventive element such as a PFP2P module 20. Loan events processing module receives repay and invest event to the PFP2P module 20. “PFP2P” event occurs, when the borrower not only repays full amount from the loan with interest, but also pays additional amount for forward investment. The event can be received from payments module, or from another module that is trustful about the fact that real life event happened. The PFP2P process after receiving event (signal) about PFP2P checks if the contract conditions for activating PFP2P option were fulfilled (no delinquent for example, minimal investment amount, etc.) and operably communicated with the scoring module 22 to receive new score and apply different (lower) interest rates from originally contracted. Scoring module can operate in any algorithms, with manual rules or machine learning etc, the PFP2P module is agnostic to the way scoring module calculates score and/or interest rate. There is general common sense assumption that the fact that borrower not just paid full amount but also invested in the same time proves that the borrower was worth the trust, which allows activation of PFP2P option of contract and reduce required interest rate during repayment. Resulted score is used in PFP2P process (see detailed diagram).

FIG. 2 illustrates a functional application of the PFP2P module 22. When PFP2P request is initiated, the request is send to a validation module 24 for validating the PFP2P event against repayment option conditions. If for any reasons, the request is not validated then the process continues to standard repayment process through a module 26.

If, however, the request is validated, then the request is forwarded to a request credit score module 28 to be forwarded to the scoring module 22 for scoring process at a scoring process module 30 for calculation of new loan rate. The scoring module 22 returns newly calculated rate back to the PFP2P module 22 and more particularly to a recalculation module 32 for recalculation of a new interest rate recalculates and to be apply new interest rate to a loan account.

A repayment event module 34 performs repayment with recalculated credit rate. The information is then forwarded to a module 36 which creates instance of investment account for former borrower, which now becomes lender. Difference between PFP2P paid amount and repayment amount is booked by a booking module 38 as initial investment amount. The information is then forwarded from the booking module 38 to an initiation module 40 which initiates standard P2P lending process with the lender (former borrower) as investor and some other party.

It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing. The drawing shows illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A computing platform for facilitating financial operations between borrowers and lenders, the computing platform comprising:
a server communicatively coupled to a network and including a processor, a database containing portions allocated to repay and invest event module (a PFP2P module), and at least one non-transitory computer-readable storage medium having computer-readable instructions stored therein, and a scoring module cooperably communicated with said server, wherein the processor executes the computer-readable instructions to:
receive signal from said scoring module to provide information to a borrower requesting the response if the borrower is ready to pay money owed plus interest as agreed with a lender to allow the borrower to select to pay the amount owed plus originally agreed interest to be paid back to the lender;
select to proceed with a savings option wherein a signal is forwarded from said PFP2P module to said scoring module operably communicated with the lender; and
provide the borrower with options to lend additional funds in return to payment of lower interest.

2. The computing platform of claim 1, including a validation module for validating the PFP2P event against repayment option conditions, wherein if for any reasons, the request is not validated then the process continues to standard repayment process through a module but if the request is validated, then the request is forwarded to a request credit score module to be forwarded to said scoring module for scoring process at a scoring process module for calculation of new loan rate.

3. The computing platform of claim 2, wherein said scoring module returns newly calculated rate back to said PFP2P module and more particularly to a recalculation module for recalculation of a new interest rate recalculates and to be apply new interest rate to a loan account.

4. The computing platform of claim 3, including a repayment event module performing repayment with a recalculated credit rate wherein the information is then forwarded to said module which creates instance of investment account for former borrower, which now becomes lender.

5. The computing platform of claim 1, wherein difference between PFP2P paid amount and repayment amount is booked by a booking module as initial investment amount.

6. The computing platform of claim 1, wherein the information is then forwarded from said booking module to an initiation module which initiates standard P2P lending process with the lender (former borrower) as investor and some other party.

7. A computer readable medium storing code representing instructions that when executed at a processor cause the processor to store instructions to perform financial transaction, comprising:
a server communicatively coupled to a network and including a processor, a database containing portions allocated to repay and invest event module (a PFP2P module),
a scoring module cooperably communicated with said server, wherein the processor executes the computer-readable instructions to: receive signal from said scoring module to provide information to a borrower requesting the response if the borrower is ready to pay money owed plus interest as agreed with a lender to allow the borrower to select to pay the amount owed plus originally agreed interest to be paid back to the lender and selecting to proceed with a savings option wherein a signal is forwarded from said PFP2P module to said scoring module operably communicated with the lender to provide the borrower with options to lend additional funds in return to payment of lower interest.

8. The computer readable medium of claim 1, adaptable for communicating with a validation module for validating the PFP2P event against repayment option conditions, wherein if for any reasons, the request is not validated then the process continues to standard repayment process through a module but if the request is validated, then the request is forwarded to a request credit score module to be forwarded to said scoring module for scoring process at a scoring process module for calculation of new loan rate.

9. The computer readable medium of claim 1, wherein said scoring module returns newly calculated rate back to said PFP2P module and more particularly to a recalculation module for recalculation of a new interest rate recalculates and to be apply new interest rate to a loan account.

10. The computer readable medium of claim 1, cooperable with a repayment event module performing repayment with a recalculated credit rate wherein the information is then forwarded to said module which creates instance of investment account for former borrower, which now becomes lender.

11. The computer readable medium of claim 1, wherein difference between PFP2P paid amount and repayment amount is booked by a booking module as initial investment amount and wherein the information is then forwarded from said booking module to an initiation module which initiates standard P2P lending process with the lender (former borrower) as investor and some other party.

12. A computing platform for facilitating financial operations between borrowers and lenders, the computing platform comprising:
a server communicatively coupled to a network and including a processor, a database containing portions allocated to repay and invest event module (a PFP2P module), and at least one non-transitory computer-readable storage medium having computer-readable instructions stored therein, and a scoring module cooperably communicated with said server, wherein the processor executes the computer-readable instructions to:
receive signal from said scoring module to provide information to a borrower requesting the response if the borrower is ready to pay money owed plus interest as agreed with a lender to allow the borrower to select to pay the amount owed plus originally agreed interest to be paid back to the lender;
select to proceed with a savings option wherein a signal is forwarded from said PFP2P module to said scoring module operably communicated with the lender;
provide the borrower with options to lend additional funds in return to payment of lower interest;
a validation module for validating the PFP2P event against repayment option conditions, wherein if for any reasons, the request is not validated then the process continues to standard repayment process through a module but if the request is validated, then the request is forwarded to a request credit score module to be forwarded to said scoring module for scoring process at a scoring process module for calculation of new loan rate;
wherein said scoring module returns newly calculated rate back to said PFP2P module and more particularly to a recalculation module for recalculation of a new interest rate recalculates and to be apply new interest rate to a loan account;
a repayment event module performing repayment with a recalculated credit rate wherein the information is then forwarded to said module which creates instance of investment account for former borrower, which now becomes lender, wherein difference between PFP2P paid amount and repayment amount is booked by a booking module as initial investment amount and wherein the information is then forwarded from said booking module to an initiation module which initiates standard P2P lending process with the lender (former borrower) as investor and some other party.
